(19) United States
(12) Patent Application Publication
(10) Pub. No.: US 2009/0101690 A1
(43) Pub. Date: Apr. 23, 2009

(54) Driving Tool

(76) Inventor: Kouji Kubo, Tokyo (JP)

Correspondence Address: DRINKER BIDDLE & REATH (DC), 1500 K STREET, N.W., SUITE 1100, WASHINGTON, DC, 20005-1209, US

(21) Appl. No.: 11/920,752

(22) PCT Filed: May 22, 2006
(86) PCT No.: PCT/JP2006/310160

§ 371 Date: Nov. 20, 2007

(30) Foreign Application Priority Data
May 25, 2005 (JP) 2005-152371

(51) Int. Cl. B27F 7/00

(52) U.S. Cl. 227/112

(57) ABSTRACT

A contact arm 15 of a driving tool is disposed to be movable in a vertical direction along an eject path on a nose part 4 disposed in a lower portion of a tool main body 2. A leading end portion of the contact arm is projected beyond a leading end of the nose part 4. In a nail driving operation, the contact arm is moved upward with respect to the nose part 4 to thereby activate an operation of a trigger. The nose part 4 includes a small-thickness wear plate 9 integrally connected to the tool main body 2, and a small-thickness driver guide 8 connected to a front portion of the wear plate 9. A leading end member 17 of the contact arm 15 is disposed to be slidable along a rear surface of the wear plate 9. An elastic contact top 18 is fixed to an outer surface of a leading end of the leading end member 17.

### TECHNICAL FIELD

The invention relates to a structure of a leading end portion of a contact arm attached to a driving tool such as a nail driving machine and a screw driving machine for safety.

### BACKGROUND ART

Generally, a driving tool such as a nail driving machine is used to drive a nail or a screw into wood or concrete. Normally, the driving tool includes a contact arm mechanism for securing safety. The contact arm mechanism is used to activate a start operation of a start trigger valve only when a contact arm, which can be moved along a nose part including a nail eject path with respect to the nose part, is pressed to a member to be nail-driven. A leading end portion of the contact arm is normally urged by a spring such that it projects in a driving direction beyond a leading end of the nose portion. When driving a nail, the leading end of the contact arm is pressed to the member to be nail-driven until the leading end of the nose part is butted against a driven portion of the member to be nail-driven, whereby the contact arm is relatively moved in an opposite direction to a contact arm pressing direction. By this relative movement of the contact arm, it is detected that the leading end of the nose part is butted to the member to be nail-driven, and an operation of a trigger is activated.

As described above, since the contact arm is urged by a spring so as to project in the nail driving direction beyond the leading end of the nose part, when the contact arm is pressed to the member to be nail-driven, it should be strongly pressed to the member to be nail-driven with a force equal to or greater than a load of the spring. Therefore, in driving a nail into a facing material, for example, in driving a pin nail into a groove of a skirting board, if the leading end of the nose part is formed so fine as to be engageable into the groove, there is a possibility that a flaw such as an impression can be caused on a surface of the member to be nail-driven due to an impact applied when the leading end of the nose part is pressed against the member to be nail-driven. When the surface of the member to be nail-driven is finished poor, in some cases, the nail driving operation must be done again. Here, since the groove of the skirting board is originally used not only to set a driving position of a nail but also to make a head of the nail invisible, a width of the groove is formed narrow.

In correspondence to this, as disclosed in JP-Y2-2556443, there is known a technology in which an eject path of the nail is structured by a front cover (driver guide) for a nose part and a lower portion of the contact arm and, the leading end portion of the nose part is formed thin in thickness as a whole.

However, when the leading end portion of the nose part is pressed to the member to be nail-driven as mentioned above, or when the nail is driven while sliding the leading end portion of the nose part in contact with the member to be nail-driven, there is a fear that it can be deformed, so that the leading end portion of the nose part cannot be formed so thin in thickness. Also, in order to prevent the member to be nail-driven from damage, the leading end portion of the nose part is structured such that a contact top made of synthetic resin can be removably mounted on the leading end of the nose part. The contact top is formed in a bag shape and is structured such that the leading end portion of the nose part can be enveloped by a whole of the contact top, except for a nail driving opening thereof. Therefore, when the contact top is mounted on the leading end portion of the nose part, it is inevitable that the leading end portion of the nose part is large in thickness as a whole. Owing to this, since the leading end portion of the nose part cannot be engaged into the groove of the skirting board, conventionally, the contact top is removed from the leading end portion of the nose part before the leading end portion of the nose part is used actually, or the nail is driven into the vicinity of the groove instead of the groove itself.

However, when the contact top is removed, the metal portion of the leading end portion of the nose part is directly contacted with the member to be nail-driven, which makes it inevitable to damage the member to be nail-driven due to the impact of the metal portion. On the other hand, when the contact top is mounted on the leading end portion of the nose part, the member to be nail-driven is difficult to be damaged but an operator is inevitably liable to drive a nail into outside the groove and thus the head of the nail driven stands out, which is unfavorable when the member to be nail-driven is used as a facing material.

### DISCLOSURE OF THE INVENTION

One or more embodiments of the invention provide a contact arm for a driving tool which can secure sufficient strength and is capable of driving a nail into even a narrow portion of a member to be nail-driven easily without damaging the member to be nail-driven.

According to one or more embodiments of the invention, a driving tool is provided with a contact arm disposed to be movable in a vertical direction along an eject path formed in a nose part provided in a lower portion of a tool main body for driving a nail. The contact arm is structured such that its leading end portion is normally projected beyond the leading end of the nose part and, when in a nail driving operation, the leading end portion is moved upward with respect to the nose part to thereby activate the operation of a start trigger. The nose part includes a small-thickness wear plate integrally connected to the tool main body and a small-thickness driver guide connected to a front portion of the wear plate. The contact arm includes a leading end member which is disposed to be slidable along a rear surface of the wear plate. Further, a contact top made of elastic material is fixed to an outer surface of the leading end portion of the leading end member.

According to one or more embodiments of the invention, the leading end member may include in two side portions thereof guide grooves respectively engageable with two side edges of the wear plate.

According to one or more embodiments of the invention, the leading end member may also include a receiving groove opened to a side and engageable with a front end of a connecting arm to be connected to an upper portion of the contact arm, and the driver guide may also include a closing portion which, when the driver guide is connected to the wear plate, closes an opening portion of the receiving groove.

According to one or more embodiments of the invention, although the leading end portion of the nose part is composed of the small-thickness wear plate and small-thickness driver guide, since the leading end member of the contact arm is disposed to be slidable in the vertical direction along the rear surface of the wear plate, the leading end portion of the nose part can be reinforced by the leading end member. Also, since what is directly contacted with the member to be nail-driven is the contact top, even when the nose part is moved while the contact top is in contact with the member to be nail-driven, no direct force can be applied to the nose part. Therefore, the nose part is sure to have sufficient strength.

Also, since the outside of the leading end of the leading end member to be directly contacted with the member to be nail-driven is covered with the contact top made of elastic material, there is no possibility that the nose part can be directly contacted with the member to be nail-driven. This makes it possible to prevent a flaw or an impression from being generated in the driven surface of the member to be nail-driven. And, because the contact top is fixed to the wear plate, there is no fear that the contact top can be removed during the driving operation.

Also, since the contact top is fixed to the leading end member and thus the contact top itself need not be held independently, the contact top itself can be reduced in thickness. This makes it possible to reduce the thickness of not only the wear plate and driver guide but also the leading end of the nose part itself, a nail can be driven even into a narrow portion with no trouble.

In the two side portions of the leading end member, there may also be formed guide grooves which can be engaged with the two side edges of the wear plate. In this case, the leading end member can be smoothly slid along the rear surface of the wear plate.

In a state where the leading end portion of the connecting arm of the contact arm is in engagement with the receiving groove of the leading end member, the opening portion of the receiving groove may be closed by the closing portion of the driver guide connected to the wear plate. This makes it possible to connect the leading end member to the connecting arm positively.

Other aspects and advantages of the invention will be apparent from the following description and the appended claims.

### BRIEF DESCRIPTION OF THE DRAWINGS

FIG. 1 is a perspective view of a nail driving tool according to an exemplary embodiment of the invention.

FIG. 2 is an enlarged perspective view of a leading end member provided on a contact arm.

FIG. 3 is an explanatory perspective view of the nail driving tool, showing how to mount the leading end member.

FIG. 4 is a perspective view of the nail driving tool, showing a state where the leading end member is mounted on a wear plate.

FIG. 5 is an enlarged view of the main portions of the nail driving tool, showing a state where the contact arm is pressed against a member to be nail-driven.

FIG. 6 is a section view taken along the A-A line shown in FIG. 5.

### DESCRIPTION OF REFERENCE NUMERALS

1: Nail driving tool
4: Nose part
8: Driver guide
9: Wear plate
15: Contact arm
17: Leading end member
18: Contact top

### BEST MODE FOR CARRYING OUT THE INVENTION

Now, description will be given below of an exemplary embodiment according to the invention with reference to the accompanying drawings.

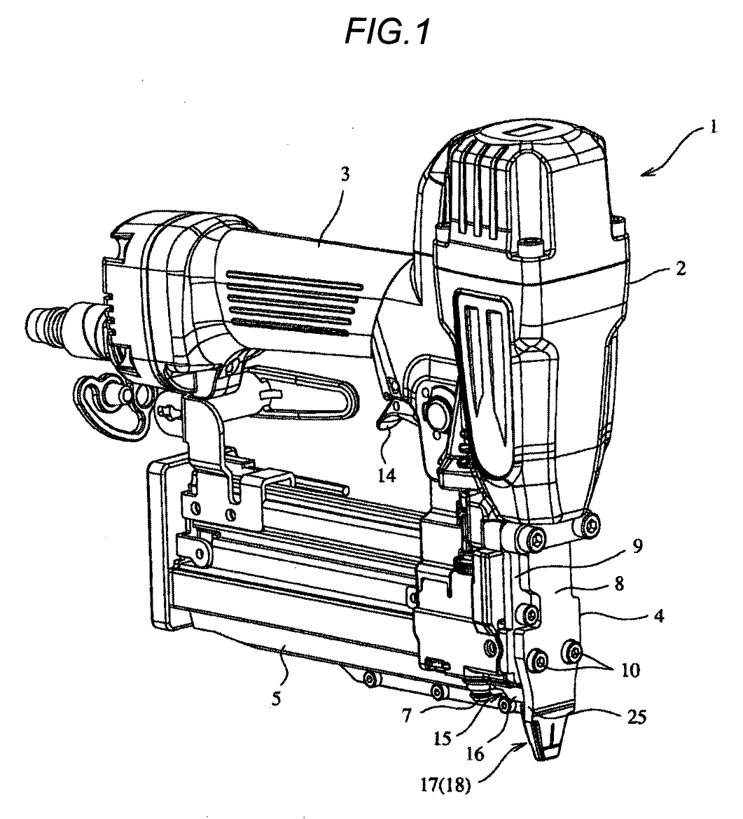

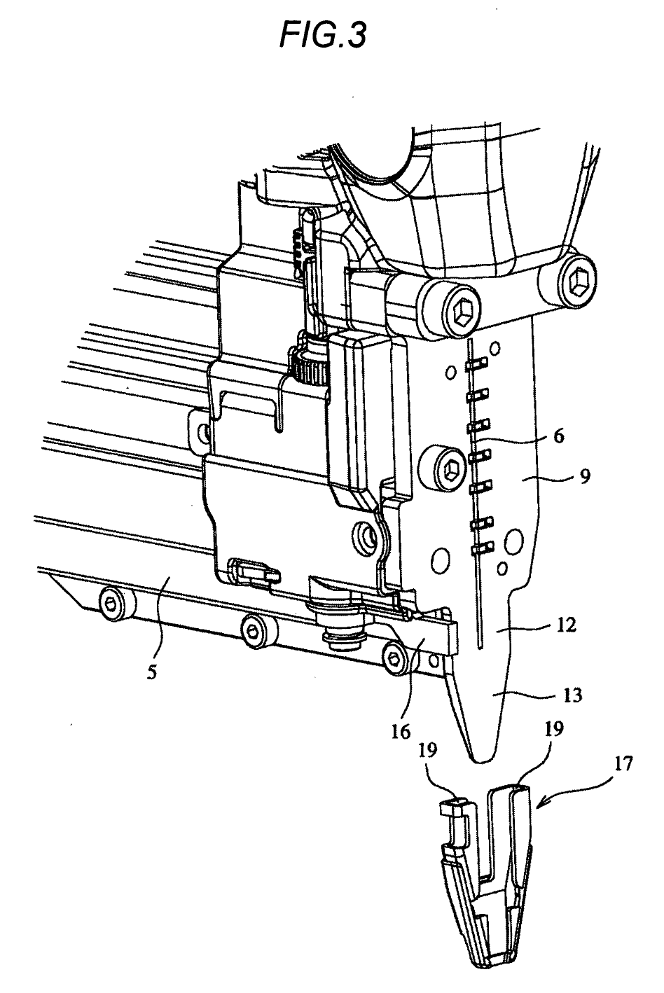

In FIG. 1, reference numeral 1 designates a nail driving tool. This nail driving tool 1 includes a tool main body 2 having a drive mechanism, a grip 3 disposed backwardly of the tool main body 2, a nose part 4 disposed on the leading end of the tool main body 2, and a rectangular-shaped magazine 5 for supplying connected nails (pin nails) to the nose part 4. In the nail driving tool 1, the leading one of nails supplied to the nose part 4 from a nail supply path (see FIG. 3) formed in the magazine 5 is driven out by a driver (not shown) which is connected integrally with a drive piston constituting the drive mechanism.

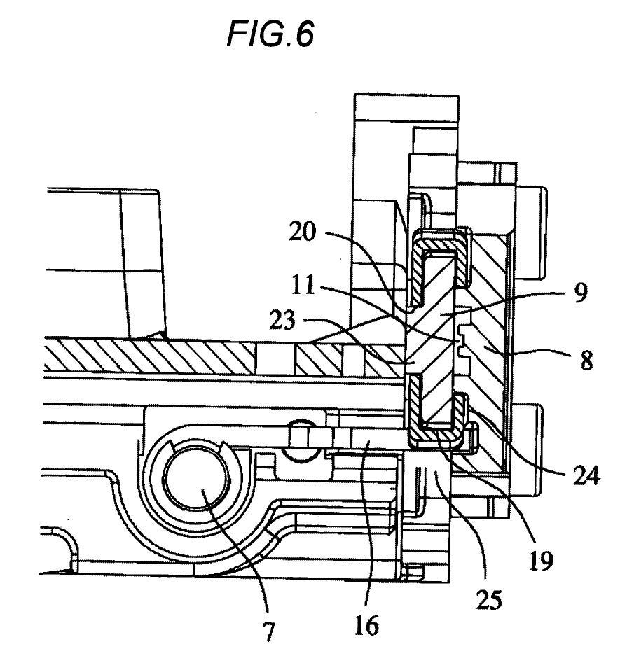

The nose part 4 is composed of a driver guide 8 forming the front wall thereof and a wear plate 9 forming the rear wall thereof. The driver guide 8 can be removably mounted on the wear plate 9 by bolts 10. When the drive guide 8 and wear plate 9 are connected together as an integral body, there is formed an eject path 11 (see FIG. 6) for nails between these two composing members. Also, the lower portions of the drive guide 8 and wear plate 9 are formed narrow in width; and, the lower end portion of this narrow-width portion 12 is formed as a tapered wedge-shaped portion 13, while the wedge-shaped portion 13 is formed small in thickness (see FIG. 3).

When driving out the nails, by pulling a start trigger 14 to activate a start trigger valve, compressed air supplied from an air compressor is fed to the drive mechanism and the above-mentioned leading nail is driven out with the pressure of the compressed air. The operation to pull the trigger 14 is linked with the operation of a contact arm 15; and, the trigger 14 is structured such that, when the contact arm 15 is actually pressed against a member to be nail-driven, it can activate the trigger valve effectively.

The contact arm 15 may be structured to satisfy the following conditions: that is, it can be slid in the vertical direction along the eject path of the nose part 4 formed in the lower portion of the tool main body 2; the leading end portion thereof is projected beyond the leading end of the nose part 4; and, when driving the nail, it can be moved upwardly relative to the nose part 4 to thereby be able to activate the operation of the trigger 14. That is, except for the portions thereof to be discussed below, the contact arm 15 is not limited to a specific structure.

The contact arm 15 includes, in the lower portion thereof, a shaft portion 7 and a connecting arm 16 extending in the back-and-forth direction thereof. On the leading end of the connecting arm 16, there is provided a leading end member 17 which is connected to the connected arm 16.

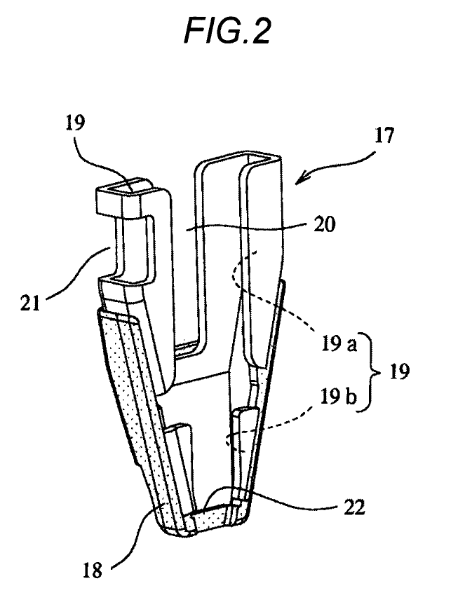

The leading end member 17, as shown in FIG. 2, is a member made of metal such as iron or stainless steel which is one size larger than the narrow-width portion 12 and wedge-shaped portion 13 formed in the lower portion of the wear plate 9 and has an outer shape corresponding to and substantially the same as these portions 12 and 13, while a contact top 18 made of elastic material is fixed to the outer surface of the leading end of the leading end member 17.

In the two side portions of the leading end member 17, there are respectively formed guide grooves 19 which can be respectively engaged with the two side edges of the wear plate 9. Each guide plate 19 is composed of an upper guide groove 19a and a lower guide groove 19b. The lower guide groove 19b is formed such that it becomes narrower toward the lowest end thereof. The side portions of the narrow-width portion 12 and wedge-shaped portion 13 formed in the lower portion of the wear plate 9 can be engaged with the inner surfaces of the guide grooves 19 and, while holding this engaged state, the leading end member 17 can be slid along the rear surface of the wear plate 9. Similarly, in the central upper portion of the leading end member 17, there is formed a vertical guide groove 20 which is in long in the vertical direction. Also, when the leading end member 17 slides upwardly and arrives at a moving end where it cannot move any further, the lower end of the of the leading end member 17 can be present substantially at the same position as the lower end of the wear plate 9.

Also, on one side of the upper portion of the leading end member, there is opened up a receiving groove 21 which faces laterally (outwardly).

The contact top 18 is made of elastic material such as synthetic resin and is integrally fixed to the outer surface of the leading end portion of the leading end member 17. The leading end of the contact top 18 is formed slightly larger in thickness than the leading end member 17 and includes a step portion 22 which is provided on and projected from the back surface side thereof for receiving the leading end portion of the wear plate 9. By the way, the means for fixing the contact top 18 may be molding adhesion, insert molding, or adhesive fixation using adhesive.

Next, the leading end member 17 is mounted on the nose part 4. That is, on the rear surface of the lower end portion of the wear plate 9, as shown in FIG. 6, there is provided a guide projecting portion 23 which can be fitted into a vertical guide groove 20 formed in the leading end member 17. Also, in the rear surface of the driver guide 8, namely, in the surface thereof facing the wear plate 9, there is formed a recessed portion 24 which is used to receive the groove edge of the guide groove 19 of the leading end member 17. Further, on one side of the driver guide 8, there is formed a closing portion 25 which, when the driver guide 8 is connected to the wear plate 9, closes the opening portion of the receiving groove 21 of the leading end member 17. This closing portion 25 is formed over the entire moving range where the leading end member 17 slides in the vertical direction.

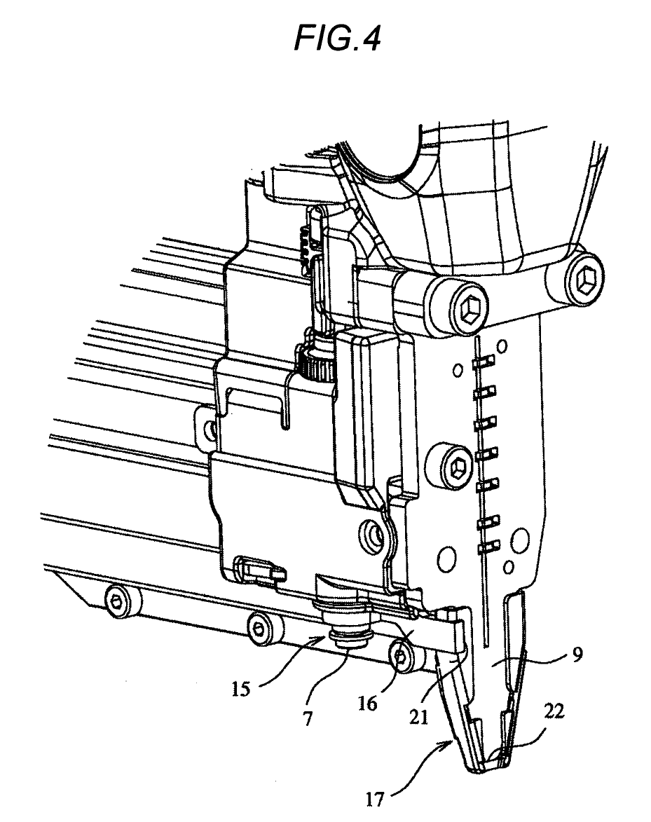

To assemble the leading end member 17 to the nose part 4 and connecting arm 16, firstly, as shown in FIG. 3, the driver guide 8 may be previously removed, while sliding the leading end member 17 from below the wear plate 9, the two side portions of the lower portion of the wear plate 9 may be engaged into the guide groove 19 of the leading end member 17. At the then time, as shown in FIG. 6, the guide projecting portion 23 provided on the rear surface of the wear plate 9 is fitted into the vertical groove 20 of the leading end member 17. Next, as shown in FIG. 4, the front end portion of the connecting arm 16 is engaged into the receiving groove 21 of the leading end member 17 from the opening portion thereof. The rear end portion of the connecting arm 16 is mounted on the shaft portion 7 of the contact arm 15 in such a manner that it can be rotated in the horizontal direction. Finally, as shown in FIG. 1, after the driver guide 8 is superimposed on the front surface of the wear plate 9, these two members are fastened using the bolts 10 to thereby connect them together as an integral body. At the then time, since the closing portion 25 of the driver guide 8 closes the opening portion of the receiving groove 21 of the leading end member 17, the connecting arm 16 can be prevented from slipping out from the receiving groove 21. Thus, the connecting arm 16 and leading end member 17 can be connected together positively.

As described above, although the leading end portion of the nose part 4 is composed of the wear plate 9 and driver guide 8 which are both small in thickness, the leading end member 17 of the contact arm 15 is disposed such that it can be slid in the vertical direction along the rear surface of the wear plate 9, thereby being able to reinforce the leading end portion of the nose part 4. Also, since what is directly contacted with a member to be nail-driven is the contact top 8, even when the nose part 4 is moved while it is in contact with the member to be nail-driven, no force is applied directly to the nose part 4. This allows the nose part 4 to have a sufficient strength.

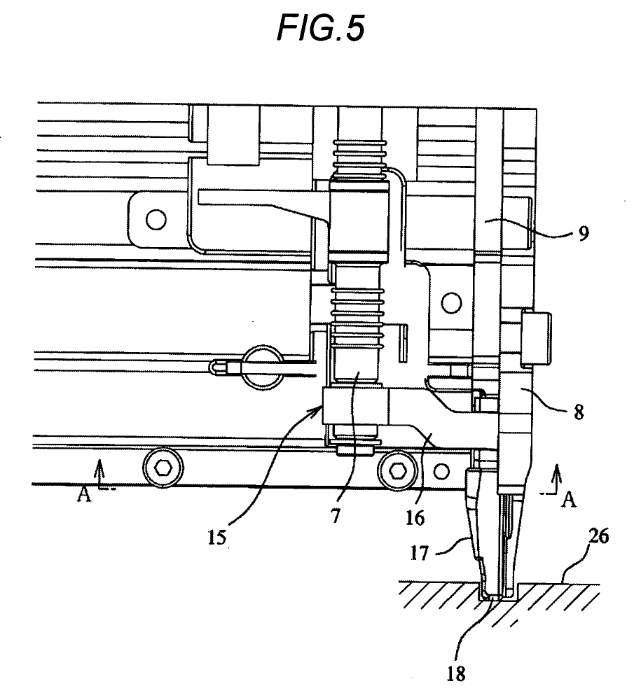

Next, description will be given below of the operation of the contact arm 15. The contact arm 15 is normally urged by a spring (not shown) in such a manner that the leading end member 17 is projected downward beyond the lower end of the nose part 4. In a nail driving operation, as shown in FIG. 5, when the leading end member 17 is pressed against a member to be nail-driven 26, the leading end member 17 is moved upward with respect to the nose part 4. At the then time, while being guided by the vertical groove 20 and the two-side guide grooves 19, the leading end member 17 is slid upward along the rear surface of the wear plate 9. And, the nose part 4 is also moved to its lowest end position, while the contact top 18 is contacted with the member to be nail-driven 26. If the trigger is pulled when the contact arm 15 is moved upward sufficiently, a trigger valve is actuated effectively to activate the drive mechanism, whereby nails supplied into the nose part 4 can be driven out.

As described above, since the leading end portion of the nose part 4 is composed of not only the small-thickness wear plate 9 and small-thickness driver guide 8 but also the small-thickness leading end member 17, and also since the contact top 18 is fixed to the leading end member 17 and thus the contact top 18 itself need not be held independent of the leading end member 17, the leading end portion of the nose part 4 can be formed thin in thickness. Therefore, in addition to the small-thickness wear plate 9 and small-thickness driver guide 8, the thickness of the leading end portion of the nose part 4 itself can also be reduced, whereby a nail can be driven with no trouble even into a narrow portion such as a groove formed in a skirting board.

And, since the outside of the leading end portion of the leading end member 17 to be contacted direct with the member to be nail-driven 26 is covered with the contact top 18 made of elastic material, generation of a flaw or an impression in the driving surface of the member to be nail-driven can be prevented effectively. Because the contact top 18 is fixed to the leading end member 17, there is no possibility that the contact top 18 can be removed from the leading end member 17 during the nail driving operation.

Also, since, in the two side portions of the leading end member 17, there are formed the guide grooves 19 which can be engaged with the two side edges of the wear plate 9 respectively, the leading end member 17 can be smoothly slid along the rear surface of the wear plate 9.

By the way, because the leading end member 17 wastes, when it wears or deforms, the driver guide 8 may be removed and the leading end member 17 may be replaced with a new one. Also, since the operation to remove the driver guide 8 is an operation which is often carried out in order to remove a nail that buckled when it was driven, that is, since it is one of the operations with which a person skilled in the art is familiar, it is not a specially troublesome operation.

The present invention is not limited to a nail driving tool but it can also be applied to a driving tool such as a screw driving tool.

Although the invention has been described heretofore in detail and with reference to the specific embodiment thereof, it is obvious to a person skilled in the art that various changes and modifications are also possible without departing from the spirit and scope of the invention.

The present application is based on the Japanese Patent Application (Patent Application No. 2005-152371) filed on May 25, 2005 and thus the contents thereof are incorporated herein as reference.

### INDUSTRIAL APPLICABILITY

The invention applicable to a structure of a leading end portion of a contact arm attached for safety to a driving tool such as a nail driving tool and a screw driving tool.

1. A driving tool comprising:
a nose part for driving a nail; and
a contact arm that is movable in a vertical direction along an eject path of the nose part, wherein a leading end portion of the contact arm is normally projected beyond a leading end of the nose part, and an operation of a start trigger is activated by moving the contact arm upward with respect to the nose part in a nail driving operation,
wherein the nose part includes a wear plate and a driver guide connected to a front portion of the wear plate, and
wherein the contact arm includes a leading end member slidable along a rear surface of the wear plate and a contact top made of elastic material and fixed to an outer surface of a leading end portion of the leading end member.

2. The driving tool according to claim 1, wherein the leading end member includes in two side portions thereof guide grooves respectively engageable with two side edges of the wear plate.

3. The driving tool according to claim 1, further comprising:
a connecting arm connected to an upper portion of the contact arm,
wherein the leading end member includes a receiving groove opened toward a side and engageable with a front end of the connecting arm, and
wherein the driver guide includes a closing portion for closing an opening portion of the receiving groove.
